(19) United States
(12) Patent Application Publication
(10) Pub. No.: US 2008/0164084 A1
(43) Pub. Date: Jul. 10, 2008

(54) Locking Differential For Electric Golf Cars And Utility Vehicles

(75) Inventors: Oliver A. Bell, Aiken, SC (US); Warren Clark, Evans, GA (US); Aric Singletary, Hephzibah, GA (US)

Correspondence Address: HARNESS, DICKEY & PIERCE, P.L.C., P.O. BOX 828, BLOOMFIELD HILLS, MI, 48303, US

(73) Assignee: TEXTRON INC., Providence, RI (US)

(21) Appl. No.: 11/620,084

(22) Filed: Jan. 5, 2007

(51) Int. Cl. B60K 28/16; B60K 1/00

(52) U.S. Cl. 180/197; 180/65.6

(57) ABSTRACT

An electric vehicle is provided with motor braking and includes a locking differential that provides positive braking on slippery surfaces so as to prevent relative movement of the first and second output shafts of the differential.

### FIELD

The present disclosure relates to electric vehicles, such as golf cars and utility vehicles, and more particularly, to a locking differential for an electric vehicle.

### BACKGROUND AND SUMMARY

The statements in this section merely provide background information related to the present disclosure and may not constitute prior art.

Electric vehicles have grown more and more popular for use as golf cars and utility vehicles. Electric vehicles are relatively low maintenance and emit zero environmentally harmful emissions. In addition, the electric vehicles are highly reliable.

Although electric vehicles have proven to be very popular and efficient, the need to improve the vehicle's manufacture and assembly still exists. One area of recent development for electrical vehicles relates to the braking system. Examples of such inventions are disclosed in U.S. Pat. Nos. 6,457,568 and 6,686,719 which are commonly assigned. In U.S. Pat. No. 6,457,568, a disc brake system for use with electric vehicles is provided. Electric vehicle disc brake systems are specially designed due to the limited ground clearance of the electric vehicle which has smaller wheels than a standard automotive vehicle. Additionally, U.S. Pat. No. 6,686,719 provides for regenerative braking, wherein electric energy is generated during braking so as to aid in the charging of the vehicle batteries.

The present invention utilizes the drive motor as a source of braking torque. Providing braking by the electric motor accomplishes two things: it returns energy back to the battery by using the electric motor 12 as a generator, and it reduces the cost and maintenance associated with a mechanical braking system. However, braking on slippery surfaces can be difficult when the drive motor is used for providing braking torque. In cases where one wheel loses traction, the other wheel is free to turn, resulting in no braking torque being applied to either of the wheels. This can also happen when an electro-mechanical brake on the motor shaft is used for emergency braking or for parking. To prevent this problem, the present disclosure provides a locking mechanism for locking both sides of the differential together so that both wheels will turn together, thus providing braking torque. In other words, when the first and second output shafts of the differential are locked together, and the input from the motor is braked, the differential is locked up and, therefore, the rear wheels are prevented from rotating. The locking differential can be actuated by a solenoid that will force the locking mechanism to lock. The lock signal is provided by a drive controller when a brake pedal is pressed a predetermined amount of its travel. The amount of the braking signal necessary to actuate the lock can be programmable.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic diagram of an electric vehicle drivetrain, according to the principles of the present disclosure;

FIG. 2 is a perspective view of a locking differential, according to the principles of the present disclosure; and

FIG. 3 is a plan view of the differential shown in FIG. 2 with the differential cover removed.

### DETAILED DESCRIPTION

The following description is merely exemplary in nature and is not intended to limit the present disclosure, application, or uses. It should be understood that throughout the drawings, corresponding reference numerals indicate like or corresponding parts and features.

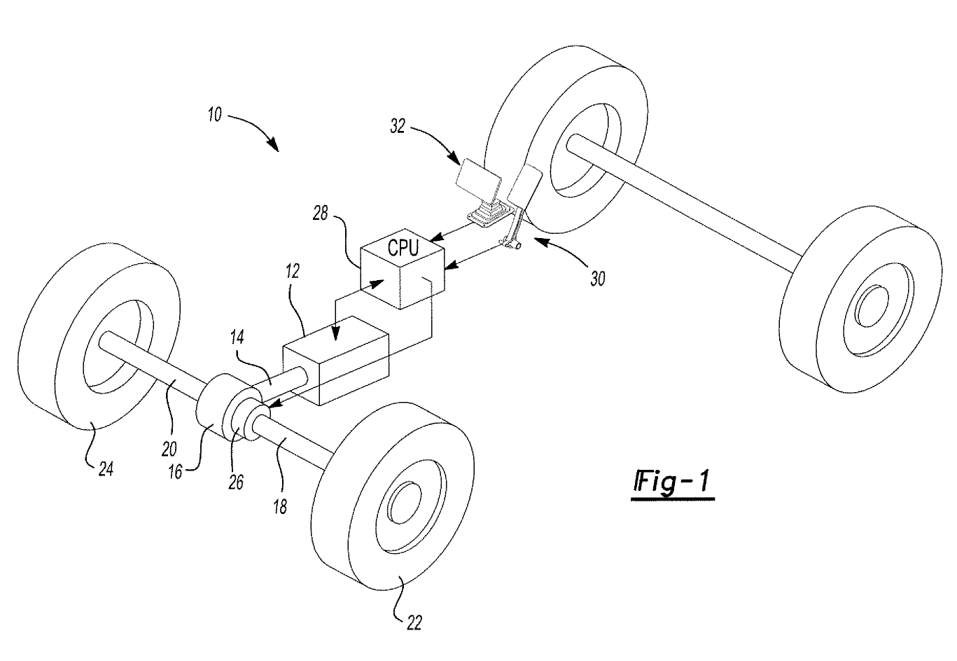

With reference to FIG. 1, an electric vehicle 10 is provided including an electric motor 12 provided with an output shaft 14 which is drivingly connected to a differential 16. The differential 16 includes first and second output axle shafts 18, 20 for driving the left and right rear wheels 22, 24, respectively. The differential 16 is a locking differential which includes a locking mechanism 26 which is controlled by a vehicle central processor unit 28. The vehicle central processing unit 28 also provides control to the electric motor 12 in response to signals received from the vehicle accelerator pedal 30 and brake pedal 32. In response to braking signals received from the brake pedal 32, the central processor unit 28 controls the electric motor to provide braking torque to the locking differential 16. Upon receipt of a braking signal from the brake pedal 32 exceeding a predetermined value, the central processor unit activates the locking mechanism 26 in order to engage the output shafts 18, 20 to one another.

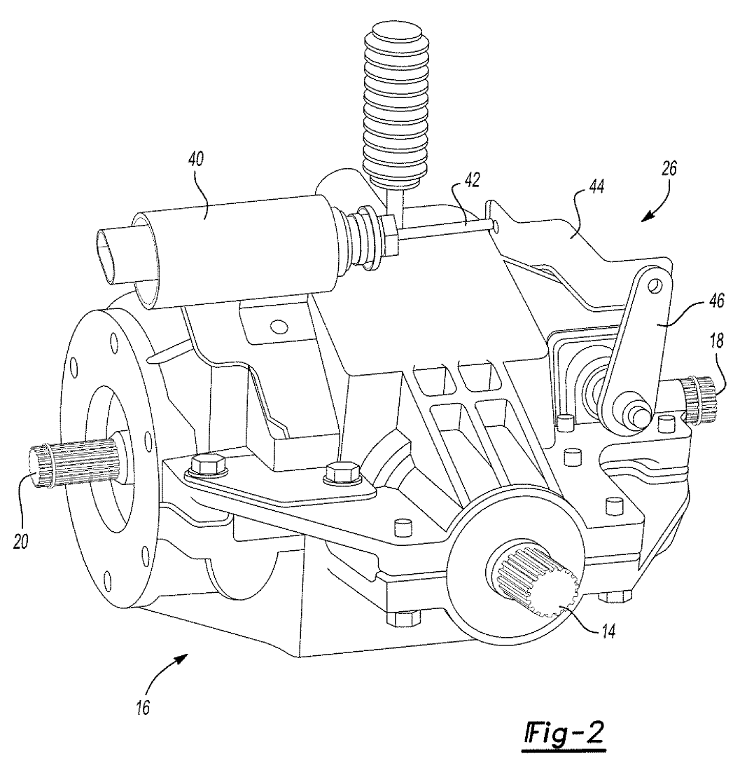

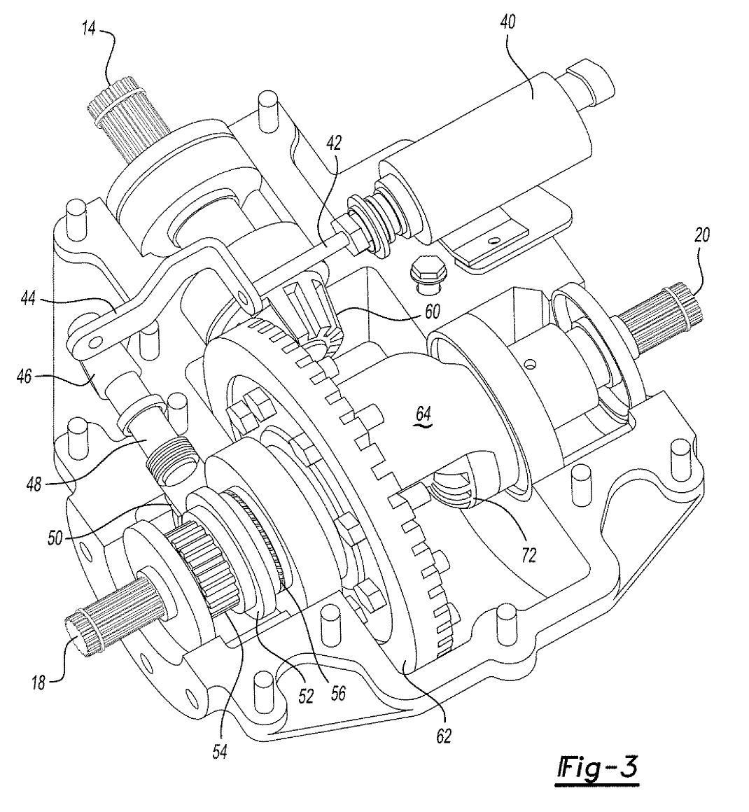

As shown in FIG. 2, the locking mechanism 26 includes an electronic solenoid 40 including an axially extending plunger 42 which is connected to a linkage member 44 which, in turn, is connected to an actuating arm 46. The actuating arm 46 is connected to a pivot shaft 48 which includes a shift fork 50, as best shown in FIG. 3. The shift fork 50 engages a coupling sleeve 52 having internal splines which engage external splines 54 and 56 which are connected to first and second output shafts 18, 20, respectively. When the coupling sleeve 52 straddles both sets of splined teeth 54, 56 of first and second output shafts 18, 20, the output shafts 18, 20 are engaged to one another so as to prevent relative rotation therebetween. When the coupling sleeve 52 is moved into engagement with only one set of splined teeth 54, 56, then the first and second output shafts are free to rotate relative to one another.

The differential 16 includes the input shaft 14 which is connected to a drive gear 60. Drive gear 60 drivingly engages input gear 62 which drives the casing 64. As is typically known in a differential, the casing 64 supports a pair of beveled gears which rotate with the casing and drive a pair of output gears (only of which, 72, is shown) which are mounted to the first and second output shafts 18, 20, respectively. It should be understood that the locking mechanism can be utilized for locking any of the components of the differential 16 together. By locking any two components, the entire differential is locked-up to thereby engage the first and second output shafts together to prevent relative rotation therebetween. In particular, a locking mechanism may directly engage the first and second output shafts to one another, or may engage the differential housing 64 to one of the output shafts 18, 20 in order to engage the first and second output shafts together.

What is claimed is:

1. A vehicle comprising:
an electric motor;
a differential drivingly connected to said electric motor and including first and second output shafts, said differential including a locking mechanism for controllably engaging said first and second output shafts together;
a pair of drive wheels each drivingly connected to a respective one of said first and second output shafts; and
a controller responsive to a braking condition of said vehicle for actuating said locking mechanism.

2. The vehicle according to claim 1, wherein said locking mechanism includes a solenoid device drivingly connected to a coupling sleeve.

3. The vehicle according to claim 2, wherein said solenoid is connected to said coupling sleeve by a linkage mechanism.

4. The vehicle according to claim 1, further comprising a brake pedal position sensor for providing a signal to said controller indicative of said braking condition.

5. The vehicle according to claim 4, wherein said controller actuates said locking mechanism when said signal from said brake pedal position sensor exceeds a predetermined level.

6. The vehicle according to claim 1, wherein said controller controls said electric motor to provide electric braking such that engagement of said first and second output shafts by said locking mechanism prevents said differential from allowing either of said pair of drive wheels to rotate.

7. A method of preventing wheel slip in an electric vehicle including a differential connecting an electric motor with a pair of drive shafts, said method comprising the steps of:
detecting a braking condition of said vehicle; and
locking said differential when a predetermined braking condition of said vehicle is detected.
